(19) United States
(12) Patent Application Publication
(10) Pub. No.: US 2013/0236691 A1
(43) Pub. Date: Sep. 12, 2013

(54) PERFORATED MONOLAYER, NONSLIP, NON-ADHESIVE SURFACE COVERING

(71) Applicant: Mark A. Calkins, La Mirada, CA (US)

(72) Inventor: Mark A. Calkins, La Mirada, CA (US)

(21) Appl. No.: 13/794,064

(22) Filed: Mar. 11, 2013

Related U.S. Application Data
(60) Provisional application No. 61/609,210, filed on Mar. 9, 2012.

(51) Int. Cl. B32B 5/18; B32B 3/26; B32B 3/30

(52) U.S. Cl. CPC B32B 5/18; B32B 3/30; B32B 3/266
USPC 428/131; 428/304.4; 428/220; 428/158

(57) ABSTRACT

Embodiments of a new non-slip, non-adhesive surface covering are disclosed, wherein a single layer of unsupported polymeric foam features a grid of perforations to facilitate the convenient hand tearing of the sheet to size. The unsupported foam includes an improved polymeric formulation to augment the tensile strength properties of the material. The enhanced structure of the polymeric foam resists the unintended separation of the incised perforations upon installation of the surface covering.

This application claims priority to U.S. Provisional Application Ser. No. 61/609,210, filed on Mar. 9, 2012, and entitled “Perforated Monolayer, Nonslip, Non-Adhesive Surface Covering,” which is incorporated herein by reference.

### BACKGROUND OF THE INVENTION

1. Field of the Invention

The present invention is directed to removable, nonslip, non-adhesive coverings which are used as shelf, drawer or storage liners. In particular, the covering sheet features a single layer of unsupported foam having an improved polymeric composition to augment the tensile strength properties of the material. The enhanced cellular structure of the polymeric foam facilitates the convenient hand tearing of the sheet to size through a grid of perforations oriented along the vertical and horizontal axes of the covering.

2. Description of the Prior Art

Shelf, drawer or storage liners have been extensively sold at retail venues and are available in a selection of self-adhesive or non-adhesive coverings. Printed wall coverings or papers were once used to protect the wooden interiors of cabinets or drawers from exposure to moisture. These permeable materials were eventually replaced with the application of decorative self-adhesive plastic sheets, which provide a greater degree of water resistance to the unfinished or varnished surfaces of cupboards. Self-adhesive shelf liners primarily consist of a facing layer of transparent, opaque or printed polymeric film coated with an underlying layer of pressure sensitive adhesive. The pressure sensitive adhesive may be combined with a siliconized release liner, which is removed prior to the application of the decorative plastic laminate. To assist the consumer in the installation of the product, the release liner typically features an imprinted grid of guide lines following the vertical and horizontal axes of the covering. The interior dimensions of cabinets or drawers are then transferred to the printed release liner prior to cutting the shelf liner to size.

Another provision known in the art includes a decorative laminate having a releasable first face with an adhesive coated reverse face, thereby permitting the sheet to be rolled upon itself and readily unrolled without the need for a separable siliconized liner. In one variation, the covering may consist of a polypropylene film having a fine pattern of micro-embossed indentations formed into the exterior facing of the sheet. The micro-embossed pattern reduces the surface area of the laminate and limits the corresponding degree of contact with the adhesive layer when wound into rolls for retail distribution. Alternatively, transparent varnishes containing an admixture of polymerized siloxanes, which are more commonly referred to as polysiloxanes, have been applied to create a releasable decorative layer for self-adhesive shelf liners made from paper or polymeric materials. Although the use of silicone coatings or micro-embossed indentations enhance the smooth separation of pressure sensitive laminates, the installation of such self-wound materials can be very troublesome in poorly accessed locations. The omission of a printed release liner eliminates the efficient means for preparing the self-adhesive covering to fit within the confined interiors of cabinets or drawers. Instead, it is necessary to first adhere the self-wound sheeting to an uncovered surface, while folding any remaining edge portions up along the adjacent walls of a cupboard, then subsequently trimming away the excess material with a razor blade.

In the prior art, the application of self-adhesive coverings are known to become frequently unmanageable. It is difficult to accurately achieve consistent straight cuts along the length and width of the material, even with the added convenience of an imprinted release liner, and especially when the shelf liner is self-wound. Irregular, oversized or non-conforming laminates that will not precisely adhere to their intended surfaces may result in the formation of entrapped air pockets beneath these impermeable coverings. Such air pockets eventually collapse under load, permanently causing unsightly creases and wrinkles. Moreover, a further problem emerges when the exposed adherent layer inadvertently folds upon itself, as the separation of these mutually bonded surfaces results in the irreparable deformation of the polymeric film.

Previous attempts have been made in the prior art to simplify the alteration of self-adhesive shelf liners so that they may correspond to the dimensions of cabinets and drawers. For example, earlier methods include the provision of forming lines of weakness into a laminate sheet to facilitate the hand-tearing of the covering to fit a surface of predetermined size.

U.S. Pat. Nos. 4,380,564 and 4,465,729, issued on Apr. 19, 1983 and Aug. 14, 1984, respectively, to Cancio et al., disclose a plastic laminate having an intersecting grid of tear lines formed into the surface of the sheet material whereby the film may be torn by hand in more than one direction. In a preferred embodiment presented in both patents, the plastic sheet materials are composed of a polymeric component consisting of a low density polyethylene having a disperse phase of calcium carbonate, with the preferred ratio of the foregoing ingredients contingent upon the dimension of the grid pattern embossed into the film. The inventors claim that the selected admixtures of polyethylene and calcium carbonate enhance the tear assisting provision of their polymeric sheet while maintaining the overall tensile strength characteristics of the material. In each disclosure, a layer of adhesive may be disposed on one side of the plastic covering, which is protected by a release liner that does not have any cross-tearable lines. Accordingly, installation of the materials taught in both patents first requires the removal of the release liner prior to hand tearing the laminate to size.

The primary disadvantage of the prior art, inherent within self-adhesive coverings which integrate perforated or cross-tearable features, concerns the inadvertent separation of the shelf liner along unselected lines of weakness, especially when attempting to pull apart mutually adhering surface portions that have accidentally folded upon themselves. The strong reciprocal bond created through such mishaps may surpass the tensile strength property of the yield lines, causing the unintended fragmentation of the plastic sheet, thereby rendering the covering unsuitable for installation. Moreover, another difficulty relates to the replacement of perforated or cross-tearable laminates after long-term use, as the molecular structure of the polymeric film degrades with age, while the self-adhesive coating becomes fully cured to the interior surfaces of cabinets or drawers. Consequently, the increased bond strength of the adhesive, combined with the embrittlement of the plastic, will result in the adverse disintegration of the material into miniscule pieces upon removal.

Although the use of self-adhesive coverings in the prior art have long provided consumers with the means to both decorate and protect shelving and drawers, the thin layer of polymeric film often fails to conceal uneven surface flaws or irregularities. More recently, the renovation or construction of kitchens and bathrooms now feature cabinets with water-resistant interior laminates, sold commercially under the Wilsonart® or Formica® brands, which are primarily manufactured from thermosetting plastic resins. Since the latest cabinet fabrications also use composite particle board materials, the application of such laminates inhibits moisture from coming into contact with the bonded wooden fibers and produces a smooth consistent surface that can be easily cleaned. Where functionality and durability is therefore enhanced, the thermoset resin permanently hardens under heat and pressure during the formation of these laminates, thereby increasing the rigidity while diminishing the impact resistance of the material. Without the benefit of a suitable protective covering, the striking force of ordinary household articles can cause pieces of the thermoset plastic sheet to break away from shelving or drawers. In view of the fact that self-adhesive coverings offer superficial protection against impact resistance, and their subsequent removal often leaves behind a viscous residue, non-adhesive shelf liners have gained widespread acceptance.

One type of non-adhesive shelf liner in the prior art consists of a knitted polyester scrim with a coating of thermally foamed polyvinyl chloride (PVC) resin. The knitted construction of the scrim provides an arrangement of woven yarns defining a pattern of apertures that correspond to a configuration of openings extending through the thickness of the cured PVC material. Alternatively, the PVC resin may be knife coated to both sides of a knitted scrim devoid of openings, or to a non-woven fabric of autogenously bonded polyester fibers, producing a solid continuous layer of supported foam. The PVC compound also includes a plasticizer that imparts a removable nonslip mechanical bond between the shelf liner and an applied surface. Such coverings provide a degree of protective cushioning and are often laminated or fused with a top decorative layer of plastic film. The basic deficiency of foamed non-adhesive liners is that they do not incorporate any provision for the consumer to conveniently alter the product to match the interior dimensions of cabinets or drawers. Moreover, the overall thickness of the shelf liner, along with the variable density of the knitted scrim and thermally cured foam, makes it difficult to maintain the uniform alignment of cuts along the length and width of the material.

Further, prior art methods—which are used to configure cross-tearable features within self-adhesive shelf liners—cannot be successfully applied to form lines of weakness in removable, nonslip, non-adhesive versions that are supported with a knitted scrim or non-woven fabric. The embossment of an intersecting grid of tear lines will not adequately diminish the tensile strength property of the woven yarns or bonded polyester fibers, where the perforation of a linear series of discontinuous holes will not effectively weaken adjacent segments of imperforated substrate.

None of the above inventions and patents, taken either individually or in combination, is seen to have solved the aforementioned problems associated with resizing removable, nonslip, non-adhesive surface coverings.

Accordingly, it is an object of the present invention to provide a removable, nonslip, non-adhesive covering sheet with an improved polymeric foam material having a grid of perforations to facilitate the convenient hand tearing of the shelf, drawer or storage liner to size.

It is a further object of the invention to provide a removable, nonslip, non-adhesive covering sheet composed of a single continuous layer of unsupported calendered foam.

It is yet another object of the invention to provide a removable, nonslip, non-adhesive covering sheet having an enhanced polymeric formulation that reinforces the dimensional stability of the unsupported calendered foam layer.

Finally, an object of the invention is to provide a removable, nonslip, non-adhesive covering sheet having the subjacent surface of the unsupported calendered foam layer configured with a fine pattern of micro-embossed indentations to assist in the hand tearing of the material.

These and other objects of the invention will be apparent to those skilled in the art from the following detailed description of the preferred embodiments of the instant invention.

### SUMMARY OF THE INVENTION

The disadvantages and limitations of the background art discussed above are overcome by the present invention. With this invention, a removable, nonslip, non-adhesive covering is provided, wherein the covering sheet features a single layer of unsupported foam having an improved polymeric composition to augment the tensile strength properties of the material. The enhanced cellular structure of the polymeric foam facilitates the convenient hand tearing of the sheet to size through a grid of perforations oriented along the vertical and horizontal axes of the covering.

In accordance with the present invention, the single layer of unsupported foam consists of a modified polymeric admixture that includes: a plasticizer; a polyvinyl chloride resin; a calcium carbonate filler; a zinc octoate heat stabilizer; a blowing agent; and a pigment. The specific proportions of the ingredients are adjusted to augment the tensile and tear strength properties along the machine and transverse directions of the unsupported foam. After thermal solidification and cooling, the enhanced tensile strength properties of the cured polymeric layer inhibit the unintended failure of the unsupported foam during perforation, or within the end use application of the surface covering material.

In a preferred embodiment, the modified polyvinyl chloride compound is cured by means of a thermal calendering process, wherein the polymeric admixture is uniformly coated on a releasable belt or casting paper which is compressed against a heated roller. In the absence of a knitted scrim or non-woven fabric substrate, the releasable belt or casting paper provides support and dimensional stability to the unsupported polymeric compound while maintaining the uniform thickness of the nonslip material during solidification. The heated roller, releasable belt or casting paper may be configured to impart a fine pattern of micro-embossed indentations on the bottom surface of the unsupported calendered foam. The micro-embossed indentations essentially weaken the tear strength properties of the nonslip layer and enhance the hand alteration of the perforated covering.

In another aspect, the disclosed polymeric material may feature a smooth top facing surface or, alternatively, may be embossed with a decorative pattern during the thermal calendering process. By this means, the thermal embossment of the composite material obscures the grid of perforations that penetrate the surface of the shelf, drawer or storage liner.

The present invention advantageously includes a grid of perforations that are oriented along the vertical and horizontal axes of the surface covering. The perforations extend through the profile of the foamed material, and are produced with a rotary or flat bed die assembly having a series of perforating rules. The perforating rules consist of a sequence of projecting teeth which are separated at regular intervals by an arrangement of indented gaps. The sequence of projecting teeth incise a linear succession of perforations into the foamed polymeric material, where the indented gaps form an alternating pattern of uncut tie portions which run adjacent to the incised perforations. The length of the projecting teeth or indented gaps may be of equivalent dimension along the vertical or horizontal axes of the surface covering or, alternatively, may be adapted to compensate for perpendicular variations in the tensile and tear strength properties inherent within the machine and transverse directions of the shelf liner.

Further objects and advantages of the present invention will be apparent from the following description of the preferred embodiments when considered in conjunction with the accompanying drawings.

### BRIEF DESCRIPTION OF THE DRAWINGS

FIG. 1 is an enlarged perspective view of a removable, nonslip, non-adhesive covering according to the present invention, showing a perforated layer of unsupported polymeric foam with torn edge portions;

FIG. 2A is a cross-sectional view drawn from lines 2A-2A of FIG. 1, showing the enhanced cellular foam construction of a removable, nonslip, non-adhesive covering according to the present invention;

FIG. 2B is a cross-sectional view similar to FIG. 2A, showing an embossed decorative facing surface of a first alternate embodiment of a removable, nonslip, non-adhesive covering according to the present invention;

FIG. 3 is a plan view showing micro-embossed indentations formed into the subjacent surface of a removable, nonslip, non-adhesive covering according to the present invention;

FIG. 4 is a schematic diagram of an apparatus for making a calendered unsupported foamed layer of a removable, nonslip, non-adhesive covering according to the present invention.

FIG. 5 is a plan view of a perforating rule segment showing a sequence of projecting teeth and indented gaps for perforating a removable, nonslip, non-adhesive covering according to the present invention.

Similar reference characters denote corresponding features consistently throughout the attached drawings.

### DETAILED DESCRIPTION OF THE PREFERRED EMBODIMENTS

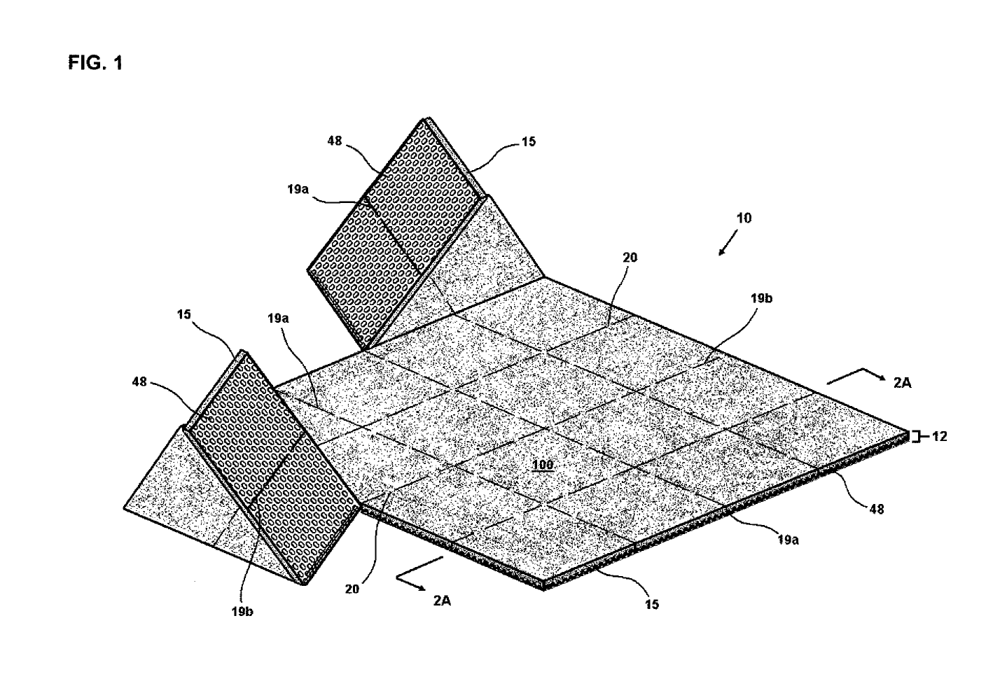

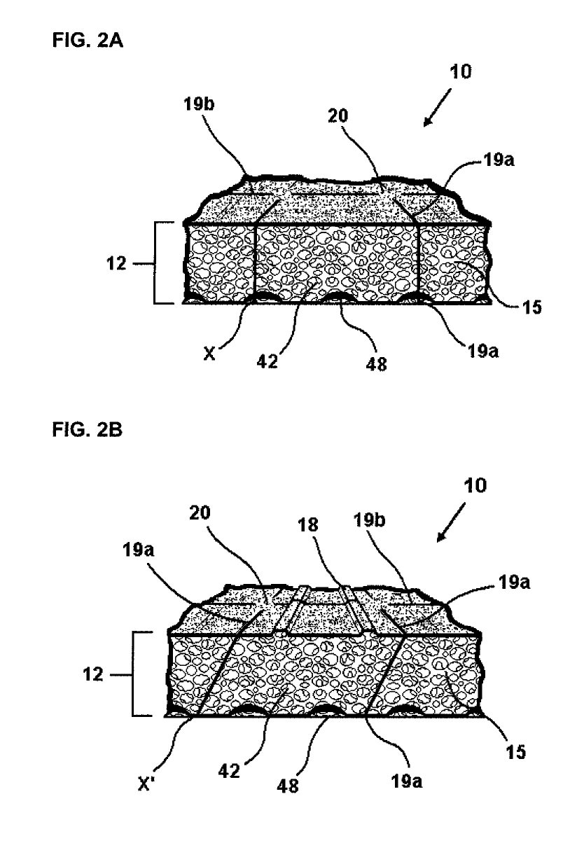

The present invention is a removable, nonslip, non-adhesive surface covering suitable for use as a shelf, drawer or storage liner, and designated generally as 10 in the drawings. With reference to FIGS. 1, 2A and 2B, the surface covering is a single unsupported layer 12 of polymeric foam 15. The enhanced cellular structure of the polymeric foam 15 facilitates the convenient hand tearing of the shelf, drawer or storage liner through a grid of perforations 19a and 19b, which are respectively located along the vertical and horizontal axes of the surface covering 10.

The chemical composition, as detailed in Table 1, reinforces the dimensional stability of the single layer 12 of unsupported foam 15. In a preferred embodiment, the polymeric admixture includes a plasticizer selected from the group of Diisononyl phthalates (DINP); Dioctyl Terephthalates (DOTP); Epoxidized Soybean Oils (ESBO); or combinations thereof. The tensile strength properties of the unsupported foam 15 may be enhanced or modified by way of blending at least two Polyvinyl Chloride Homopolymer (PVC Homopolymer) emulsion resins, each having divergent viscoelastic properties, into the compound formulation. The first PVC resin, comprising at least 26.45% of the polymeric formulation, has a lower Viscosity Number of approximately 116 ml/g, and a K-Value of approximately 68. The second PVC resin, comprising at least 17.63% of the polymeric formulation, has a higher Viscosity Number of approximately 124 ml/g, and a K-Value of approximately 70. The raw material properties of the respective resins were tested at 73° F. according to ISO protocol 1628-2, and are commercially available under the Vinnolit® brand from Vinnolit GmbH & Co. KG. The admixture also comprises a Calcium Carbonate (CaCO₃) filler, along with a Zinc Octoate (C₇H₁₅COO) 2Zn heat stabilizer that is sold under the Akerostab® M-823 brand from Akeros Chemicals. The chemical blowing agent is selected from the group of hydrazine derivatives, and is more particularly an Azodicarbonamide powder that is suspended in the resin formulation. It can be appreciated that the polymeric compound may also contain additives that are standard in the art, including pigments, matting agents, UV inhibitors, flame-retardants, biocides, fungicides, and other ingredients. The single layer 12 of unsupported foam 15 may also consist of homopolymeric formulations consisting of natural or synthetic resins that include Latex; Polypropylene (PP), Polyurethane (PUR); Polyvinyl Chloride Homopolymer (PVC Homopolymer); Ethylene Vinyl Acetate (EVA); or other appropriate compounds.

TABLE 1

| Compound Ingredient | Parts by weight |
|---|---|
| DOTP Plasticizer | 48.94 ± 5% |
| PVC Resin A | 26.45% ± 5% |
| PVD Resin B | 17.63% ± 5% |
| Calcium Carbonate (CaCO₃) | 4.23 ± 5% |
| Azodicarbonamide (C₇H₁₅COO)2Zn | 1.69 ± 5% |
| Zinc Octoate | .21 ± 5% |
| Pigment | .85 ± 5% |

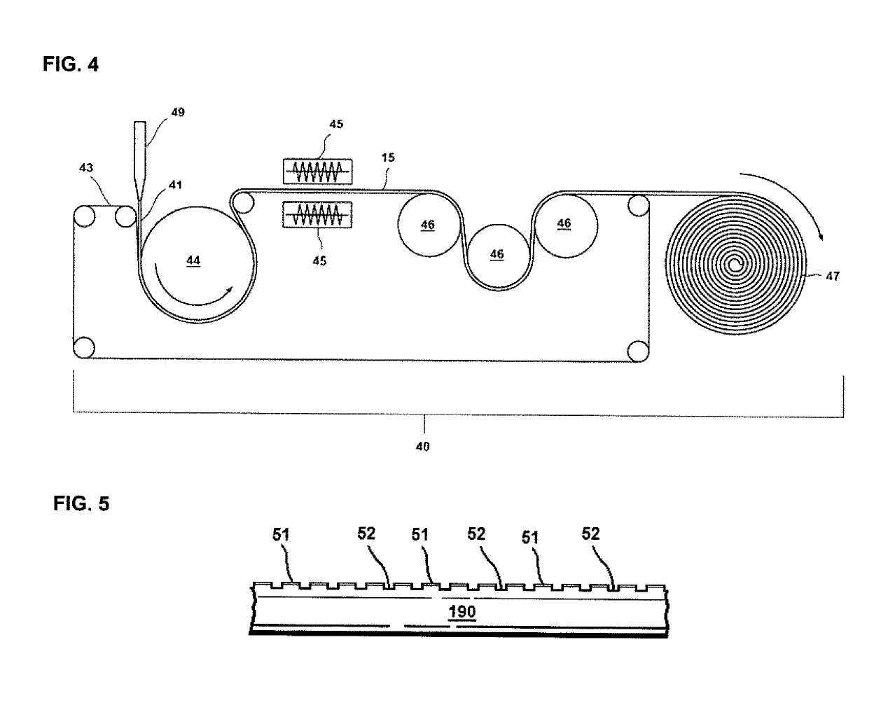

The layer of unsupported foam 15 can be made according to the process that is schematically depicted in FIG. 4. The polyvinyl chloride compound 41 is cured by means of a thermal calendering process 40, wherein the polymeric admixture is supplied by metering vat 49 and uniformly coated on a releasable belt 43. The polyvinyl chloride compound 41 and releasable belt 43 are then compressed under tension against a heated roller 44. As an alternative, a releasable casting paper (not shown) may also be used. In the absence of a knitted scrim or non-woven fabric, the releasable belt 43 or casting paper functions as a carrier for the uncured polymeric compound 41. The carrier maintains the uniform thickness of the foam material 15 during thermal solidification. In a preferred embodiment, the layer of unsupported polyvinyl chloride foam 15 is in the range of 1.275 mm to 1.675 mm in thickness. The layer of the polyvinyl chloride foam 15 may be partially solidified as the material exits the heated roller 44, and may be further cured through the use of heated ovens 45. The solidified layer of polyvinyl chloride foam 15 is then cooled through contact with cooling rollers 46, and collected on a take-up roll 47. As illustrated in FIGS. 2A and 2B, the facing surface of the cured polyvinyl chloride foam 15 may be smooth or, alternatively, feature a decorative embossment 18 that may be thermally formed by the heated roller 44. In a preferred embodiment, the releasable belt 43 or casting paper is additionally configured to impart a fine pattern of micro-embossed indentations 48 within the subjacent surface of layer 12. The pattern of micro-embossed indentations 48 are alternately spaced at 0.889 mm intervals, although other micro-embossed configurations may also be used. The micro-embossed indentations 48 essentially weaken the tear strength properties of the unsupported foam 15 and enhance the hand alteration of the perforated surface covering 10. Alternatively, the subjacent surface of layer 12 may consist of a smooth surface (not shown) without departing from the scope of the present invention.

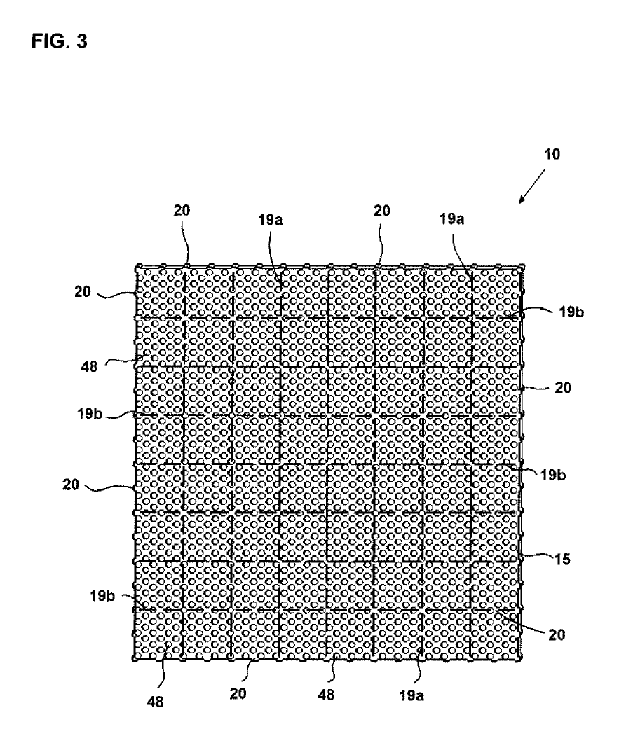

With further reference to FIGS. 1, 2A-2B, and FIG. 3, the present invention includes a grid of perforations 19a and 19b that are oriented at right angles along the vertical and horizontal axes of the surface covering 10. The perforations 19a and 19b extend through the profile of the single layer 12 of the shelf, drawer or storage liner 10. The perforations 19a or 19b may extend at perpendicular angles x through the profile of layer 12 or, as illustrated in FIG. 2B, the perforations 19a or 19b may extend through the surface covering at beveled angles x′. In a preferred embodiment, to reduce the visible appearance of perforations scored into the surface of the shelf, drawer or storage liner 10, the perforations 19a and 19b are incised from the bottom of layer 12. Alternatively, the perforations 19a and 19b may be incised from the obverse surface of the surface covering 10. In a specific embodiment, the perforations 19a run linearly along the machine direction of the surface covering 10, and are spaced in parallel along the transverse direction of the material in 6.35 mm increments. Conversely, the perforations 19b run linearly along the transverse direction of the surface covering 10, and are spaced in parallel along the machine direction of the material in 6.35 mm increments. Accordingly, the corresponding series of perforations 19a and 19b produce a pattern of interconnecting square portions 100 having all four sides that are approximately 6.35 mm in length. In an alternate embodiment, the parallel arrangement of linear perforations 19a or 1% may not be equidistantly spaced along the machine or transverse directions of the surface covering 10. Moreover, the horizontal or perpendicular arrangement of linear perforations, 19a or 19b, may not be necessarily arranged at corresponding parallel intervals to form a uniform grid along the machine or transverse directions of the shelf, drawer or storage liner 10.

The perforations 19a and 19b are produced with a rotary or flat bed die assembly having a series of perforating rules that are oriented at right angles. As disclosed in FIG. 5, the perforating rules 190 consist of a sequence of projecting teeth 51, which are separated at regular intervals by an arrangement of indented gaps 52. The sequence of projecting teeth 51 incise a linear succession of perforations 19a and 19b into the single layer of material 12, where the indented gaps 52 form an alternating pattern of uncut tie portions 20 which run adjacent to the incised perforations. In a preferred embodiment, the projecting teeth 51 are each 238 mm in length, where the indented gaps 52 span a distance of 0.8128 mm each. In an alternate embodiment, the length of projecting teeth 51, or indented gaps 52, which are machined into the series of perforating rules 190, may be adapted to compensate for perpendicular variations in the tensile and tear strength properties inherent within the machine and transverse directions of the surface covering 10. For example, if the tensile and tear strength properties of the unsupported layer 12 of polymeric foam 15 are greater in the machine direction, than the tensile and tear strength properties oriented along the transverse direction, the perforating rules 190—which in this instance form the series of linear perforations 19a—would be altered to lengthen the dimension of each projecting tooth 51, while the span of each indented gap 52 would be similarly decreased. Accordingly, modification in the dimensioning of the projecting teeth or indented gaps equalizes the tear resistance of the perforated grid along the vertical and horizontal axes of the surface covering 10.

Even though numerous characteristics and advantages of the present invention have been set forth in the foregoing description, together with details of the structure and function of the preferred embodiments, the above disclosure is illustrative only. Changes may be made in detail, especially in matters of shape, size and arrangement of parts within the principles of the invention to the full extent indicated by the broad general meaning of the terms in which the appended claims are expressed.

1. A surface covering comprising:
a single layer of unsupported polymeric foam,
wherein,
the primary layer of polymeric foam is comprised of a copolymeric blend of at least two emulsion resins.

2. The surface covering according to claim 1, wherein the single layer of polymeric foam contains at least one resin selected from the group consisting of latex, polypropylene, polyurethane, polyvinyl chloride, and ethylene vinyl acetate.

3. The surface covering according to claim 1, wherein the single layer of polymeric foam is composed of a thermally cured polyvinyl chloride (PVC) compound, the compound further comprising first and second homopolymeric resins having divergent viscoelastic properties to augment the tensile strength properties of the polymeric foam; wherein:
(a.) the first homopolymeric resin has a viscosity number in the range of 111 ml/g to 121 ml/g, and a K-value in the range of 63 to 73; and wherein
(b.) the second homopolymeric resin has a viscosity number in the range of 119 ml/g to 129 ml/g, and a K-value in the range of 65 to 75.

4. The surface covering according to claim 3, wherein the polymeric compound is further comprised of a plasticizer, calcium carbonate, a chemical foaming agent, a heat stabilizer, and a pigment.

5. The polymeric compound according to claim 4, wherein the plasticizer is selected from the group consisting of Diisononyl phthalates (DINP), Dioctyl terephthalates (DOTP), Epoxidized Soybean Oils (ESBO), or combinations thereof.

6. The surface covering according to claim 1, wherein the single layer of polymeric foam further includes a plurality of vertical and horizontal perforated lines, the vertical and horizontal perforated lines forming a separable grid.

7. The surface covering according to claim 1, wherein the single layer of polymeric foam has a thickness in the range of 1.275 mm to 1.675 mm.

8. The surface covering according to claim 1, wherein the single layer of polymeric foam has a smooth obverse surface and an opposing subjacent surface configured with a fine pattern of micro-embossed indentations.

9. The surface covering according to claim 1, wherein the single layer of polymeric foam has opposing smooth continuous surfaces.

10. A surface covering comprising:
a single layer of unsupported polymeric foam,
wherein,
the primary layer of polymeric foam is comprised of a homopolymeric emulsion resin.

11. The surface covering according to claim 10, wherein the single layer of polymeric foam contains a resin selected from the group consisting of latex, polypropylene, polyurethane, polyvinyl chloride, and ethylene vinyl acetate.

12. The surface covering according to claim 10, wherein the single layer of polymeric foam is composed of a thermally cured polyvinyl chloride homopolymer (PVC Homopolymer) compound.

13. The surface covering according to claim 12, wherein the polymeric compound is farther comprised of a plasticizer, calcium carbonate, a chemical foaming agent, a heat stabilizer, and a pigment.

14. The polymeric compound according to claim 13, wherein the plasticizer is selected from the group consisting of Diisononyl phthalates (DINP), Dioctyl terephthalates (DOTP), Epoxidized Soybean Oils (ESBO), or combinations thereof.

15. The surface covering according to claim 10, wherein the single layer of polymeric foam further includes a plurality of vertical and horizontal perforated lines, the vertical and horizontal perforated lines forming a separable grid.

16. The surface covering according to claim 10, wherein the single layer of polymeric foam has a thickness in the range of 1.275 mm to 1.675 mm.

17. The surface covering according to claim 10, wherein the single layer of polymeric foam has a smooth obverse surface and an opposing subjacent surface configured with a fine pattern of micro-embossed indentations.

18. The surface covering according to claim 10, wherein the single layer of polymeric foam has opposing smooth continuous surfaces.
